(19) United States
(12) Patent Application Publication
(10) Pub. No.: US 2005/0100021 A1
(43) Pub. Date: May 12, 2005

(54) Data transmission in a mobile station of a wireless packet-switched data system

(75) Inventor: Arto Suomi, Tampere (FI)

Correspondence Address: CRAWFORD MAUNU PLLC, 1270 NORTHLAND DRIVE, SUITE 390, ST. PAUL, MN, 55120, US

(73) Assignee: Nokia Corporation

(21) Appl. No.: 10/950,906

(22) Filed: Sep. 27, 2004

(30) Foreign Application Priority Data
Sep. 30, 2003 (FI) 20031414

(51) Int. Cl. H04L 12/56

(52) U.S. Cl. 370/395.21

(57) ABSTRACT

The present invention relates to a method for data transmission in a wireless packet-switched data system that requires the definition of a transmission order of a data packet of a first data flow and a data packet of a second data flow. In the method, the transmission order of the data packets is defined on the basis of at least one classification parameter attached to them. The parameters defining the quality-of-service classes of the first and second data flows are checked according to the classification parameter. The data packet of the data flow having the higher quality-of-service class is transmitted first.

### FIELD OF THE INVENTION

The invention relates to data transmission in a mobile station of a wireless packet-switched data system, and especially to defining the transmission order of packets.

### BACKGROUND OF THE INVENTION

In a packet-switched data transmission system, one example of which is GPRS (General Packet Radio System), there are systems for providing a different quality of service (QoS) for the needs of different applications. In packet-switched data transmission, data traffic is typically bursty requiring temporarily a lot of bandwidth, but when time-critical data, such as speech, is transmitted, the delay is more significant. When allocating radio resources, it is possible to take into account the transmission rate requirements of the data to be transmitted. It is also possible to transmit several different data flows substantially simultaneously from a mobile station. If several packets are to be transmitted, they can be buffered in a transmission queue before transmission to the wireless transmission path. Packets are conventionally transmitted from the queue in the order of reception, but in many cases it would be good to be able to prioritize the packets; it would be especially preferable to be able to prioritize time-critical data.

The RLC/MAC protocol of the GPRS system is described in the 3GPP specification 3GPP TS 44.060, version 6.4.0, September 2003. RLC/MAC provides transmission services to the packets of the higher layers by utilizing a wireless transmission medium shared by several mobile stations. The RLC layer defines the segmentation and reassembly of LLC data units and also provides link adaptation. For transmitting LLC data units over the radio interface, RLC/MAC utilizes a TBF (Temporary Block Flow) connection, which is a physical radio link for transmitting LLC data units unidirectionally between a mobile station and network. An LLC data unit contains user data or GPRS protocol signalling. TBF is released when the higher-level transmission mode ends. Two different transmission modes, acknowledging and unacknowledging, can be used on the RLC layer and they require different TBF connections. Paragraph 8.1.1.1.2 of the above specification describes prioritization performed on the RLC layer, according to which a Radio Priority parameter allocated by the GPRS network is used as a classification parameter in defining the transmission order of the packets of different data flows on the RLC/MAC layer. The Radio Priority parameter has only four values, and one of them (the highest priority) is reserved for signalling purposes only. This parameter is generally also used in GPRS networks for taking into consideration various subscription differences; for example, a corporate subscriber is given a higher Radio Priority parameter value than a private user who gets a cheaper service. The Radio Priority parameter is typically also used in prioritizing between different mobile stations in networks. It is thus possible, and in fact probable, that even though two PDP contexts of a mobile station have different quality-of-service profiles, the network gives both the same Radio Priority parameter. This is why the Radio Priority parameter alone is not sufficient to efficiently prioritize several data flows. The above-mentioned GPRS RLC specification 44.060 also describes the use of a secondary prioritization criterion, Peak Throughput Class parameter, in the case that the packets to be transmitted have the same Radio Priority parameter. However, this parameter is derived from the maximum uplink bit rate parameter and does not describe in any way the real-time properties of the data flow.

### BRIEF DESCRIPTION OF THE INVENTION

It is thus an object of the invention to develop an improved solution in such a manner that the properties of a data flow can better than before be taken into consideration when defining the transmission order of data packets. The object of the invention is achieved by a method and mobile station that are characterized by what is stated in the independent claims. Some preferred embodiments of the invention are described in the dependent claims.

The invention is based on the idea that a transmission order is defined for data packets on the basis of at least one classification parameter such that parameters defining the quality-of-service class of a first and a second data flow are checked according to the classification parameter. The data packet of the data flow having the higher quality-of-service class is transmitted first. The data flow generally refers to the logical transmission link of packet-switched data, for example the PDP context of the GPRS system. The parameter defining the quality-of-service class is generally any parameter that indicates an application type. For a telephony application, for instance, it is possible to define a quality-of-service class that indicates that the application in question requires a slight delay. It should also be noted that for one application, it is also possible to use several quality-of-service classes depending on the use, for example.

An advantage of the arrangement of the invention is that on lower layers, such as the RLC/MAC layer of the GPRS system, it is possible to observe better than before the properties of the data to be transmitted and to prioritize data packets transmitting real-time data. This is especially useful in delay-critical applications, such as in the transmission of audio and video data over a packet-switched network.

### BRIEF DESCRIPTION OF THE FIGURES

The invention will now be described in greater detail by means of preferred embodiments and with reference to the attached drawings, in which

FIG. 1 illustrates the GPRS system,

FIG. 2 shows a protocol stack used in the transmission of user data in the GPRS system, and

FIG. 3 illustrates a method according to a preferred embodiment.

### DETAILED DESCRIPTION OF THE INVENTION

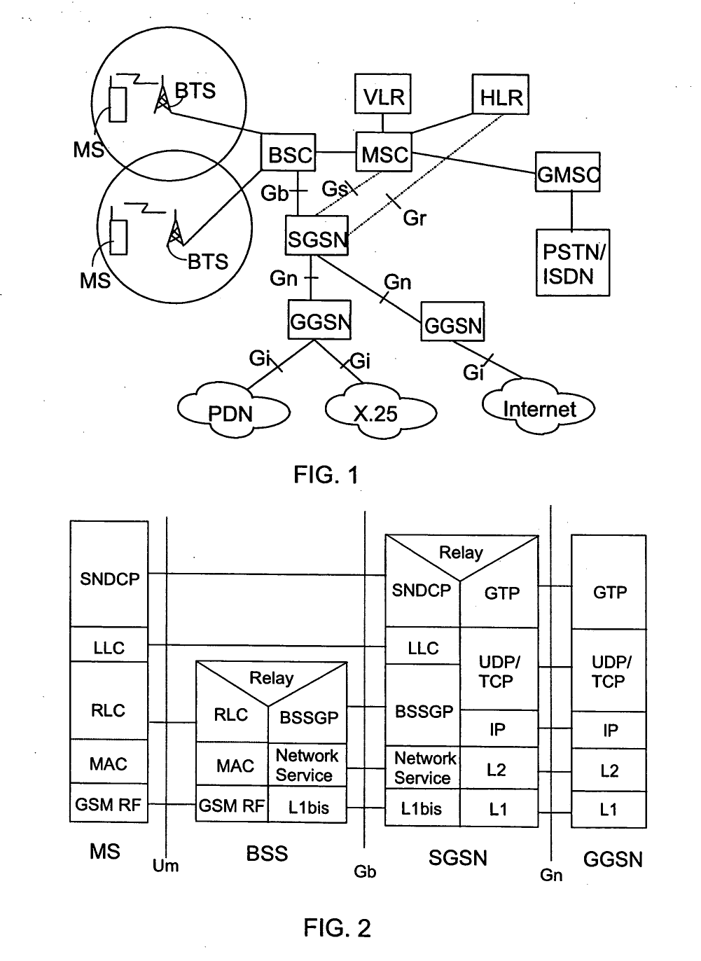

FIG. 1 illustrates how the GPRS system is built on the basis of the GSM system. The GSM system comprises mobile stations MS that are connected over a radio path to base transceiver stations BTS. Several base transceiver stations BTS are connected to a base station controller BSC that controls the radio frequencies and channels of the base transceiver stations. The base station controllers BSC and base transceiver stations BTS form a base station subsystem BSS. The base station controllers BSC are, in turn, connected through an A interface to a mobile services switching centre MSC that takes care of connection establishment and call routing to the correct addresses. For this, two databases are used that contain information on the mobile subscribers: a home location register HLR, which contains information on all subscribers in the mobile network and the services they subscribe to, and a visitor location register VLR, which contains information on mobile stations visiting the area of a given mobile services switching centre MSC. The mobile services switching centre MSC is, in turn, in contact with other mobile services switching centres through a gateway mobile services switching centre GMSC, and with the public switched telephone network PSTN. It should be noted that it is also possible to arrange radio access to the GPRS system by using other systems than BSS, for instance through GERAN (GSM EDGE Radio Access Network) radio access or UTRA (UMTS Terrestrial Radio Access) radio access, and the present method can also be applied to mobile stations supporting these two.

The GPRS system connected to the GSM system comprises two nearly independent functions, i.e. a gateway GPRS support node GGSN and a serving GPRS support node SGSN. The GPRS network can comprise several gateway and serving support nodes and, typically, several serving support nodes SGSN are connected to one gateway support node GGSN. The serving support node SGSN is connected to a mobile station MS through a mobile network. The connection to the mobile network (interface Gb) is typically established either through the base transceiver station BTS or base station controller BSC. The task of the serving support node SGSN is to detect mobile stations capable of GPRS connections in its service area, to transmit and receive data packets to and from the mobile stations, and to monitor the location of the mobile stations in its service area. The serving support node SGSN is further connected to the mobile services switching centre MSC and the visitor location register VLR through a signalling interface Gs, and to the home location register HLR through an interface Gr. The home location register HLR also stores GPRS records that contain the content of subscriber-specific packet data protocols.

The gateway support node GGSN serves as a gateway between the GPRS network and an external packet data network PDN. Examples of external packet data networks are the GPRS network of another network operator, the Internet, an X.25 network or a private local area network. The gateway support node GGSN is connected to the data networks through an interface Gi. Data packets transmitted between the gateway support node GGSN and serving support node SGSN are always encapsulated according to the GPRS standard. The gateway support node GGSN also contains the PDP (Packet Data Protocol) addresses of GPRS mobile stations and the routing information, i.e. SGSN addresses. Routing information is thus used to link data packets between the external packet data network and the serving support node SGSN. The GPRS core network between the gateway support node GGSN and the serving support node SGSN utilises an IP protocol, preferably IPv6 (Internet Protocol, version 6).

In packet-switched data transmission, the term ‘context’ is usually used for the connection provided by the telecommunications network between a terminal and network address. This refers to the logical link between destination addresses, through which data packets are transmitted between the destination addresses. This logical link may exist even though no packets are transmitted and, consequently, does not take up system capacity from other connections. In the GPRS system, one or more PDP contexts, each possibly having a different service-of-quality profile, can be arranged for a mobile station. In accordance with the quality-of-service profile negotiated during the establishment of the PDP context, a radio access bearer assignment procedure is reserved so that the mobile station MS can be provided a service that is as close as possible to the quality-of-service profile. The PDP address identifies the mobile station, to which the PDP context belongs. Several PDP contexts (primary PDP context and one or more secondary PDP contexts) can use one PDP address. Further information on the basic functions of the GPRS system can be found in the 3GPP specification 3GPP TS 23.060, versions 6.1.0, June 2003.

FIG. 2 shows a protocol stack used in the transmission of user data between the mobile station MS and the gateway supporting node GGSN in a GPRS system. Data transmission between the mobile station MS and the base station subsystem BSS of the GSM network over a radio interface Um takes place in accordance with a normal GSM protocol. On the interface Gb between the base station subsystem BSS and serving support node SGSN, the lowest protocol layer is left open and on the second layer, either an ATM or Frame Relay protocol is used. The BSSGP (Base Station System GPRS Protocol) layer on top of this adds routing and quality-of-service definitions and signalling related to data packet acknowledgment and Gb interface management to the data packets being transmitted.

Direct communication between the mobile station MS and the serving support node SGSN is defined on two protocol layers, SNDCP (Sub-Network Dependent Convergence Protocol) and LLC. In the SNDCP layer, the user data being transmitted is segmented into one or more SNDC data units, whereby the user data and a TCP/IP or UDP/IP header field related to it can be compressed. The SNDC data units are transmitted in LLC frames, to which address and verification information essential for data transmission is added and in which frames the SNDC data units can be encrypted. The task of the LLC layer is to maintain the data transmission connection between the mobile station MS and the serving support node SGSN and to take care of the retransmission of damaged frames. The serving support node SGSN routes data packets coming from the mobile station MS on to the correct gateway support node GGSN. This connection uses a tunnelling protocol (GTP, GPRS Tunnelling Protocol) that encapsulates and tunnels all user data and signalling transmitted through the GPRS core network. The GTP protocol is run on top of the IP used by the GPRS core network.

Messages transmitted through the LLC layer are called LLC packet data units (LLC PDU). An LLC-layer data link connection providing services to the GPRS mobility management or to the SNDCP layer is identified by a service access point identifier (SAPI) both in the SGSN node and the mobile station MS. For instance, when a packet data unit (SNDCP PDU) comprising an identifier NSAPI identifying a PDP context is received from the SNDCP layer, it is transmitted for instance by using an LLC SAPI identifier 3 (which is reserved for the data units of the SNDCP layer). The LLC data units are segmented and recoded into RLC/MAC-layer blocks. The LLC blocks are then transmitted using a TBF connection established for the time of the data transmission.

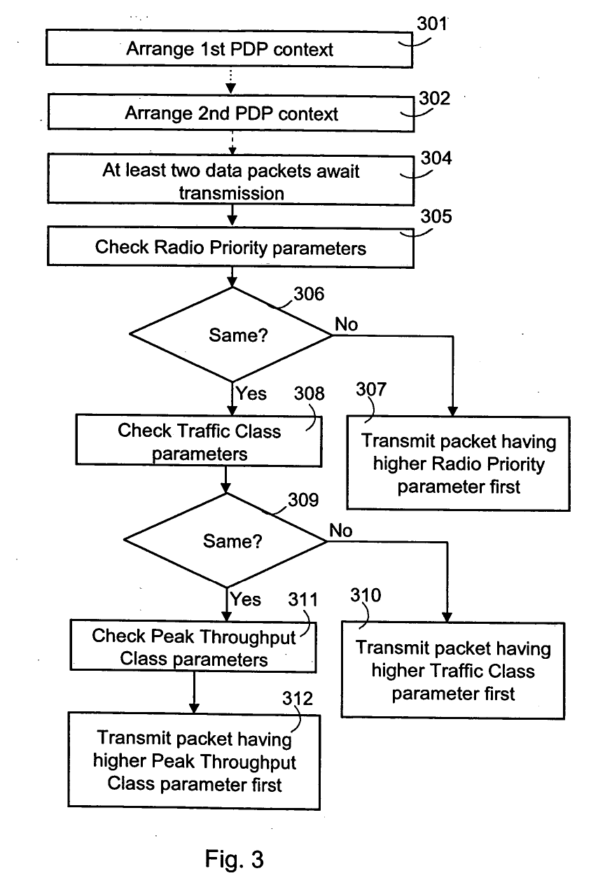

The mobile station MS comprises memory, a user interface, a transceiver for arranging wireless data transmission, and a central processing unit comprising one or more processors. In the mobile station MS, it is possible to implement various applications by executing a computer program code stored in the central processing unit. By means of a computer program code executed in the central processing unit and/or hardware solutions, the mobile station MS can be arranged to perform tasks defined for the protocols illustrated in FIG. 2. By means of computer program codes executed in the central processing unit and/or hardware solutions, the mobile station MS can also be arranged to implement inventive functions related to the selection of the transmission order of the data packets to be transmitted and organizing means, some embodiments of which are illustrated in FIG. 3.

FIG. 3 illustrates a classification method for the definition of the transmission order of data packets according to one embodiment. The method can be applied to the RLC/MAC layer of a mobile station according to the GPRS system. In step 301, a first PDP context is arranged for the mobile station MS. It is then possible to act in the manner described in the 3GPP specification 23.060, paragraph 9.2.2, whereby the mobile station typically requests in a PDP context activation request a quality-of-service profile according to the quality-of-service needs received from the application. It should be noted that the quality-of-service profile to be requested and especially the quality-of-service class is typically determined according to the application type. The application can then request from the lower layers a service according to a certain quality-of-service class, or it is defined in advance in the mobile station MS that a PDP context according to a certain quality-of-service class is always requested for a certain application. It is also possible that the user and/or end-to-end quality-of-service negotiation of the application defines the quality-of-service profile. If the PDP context can be activated, SGSN transmits a PDP context activation reply that comprises an information element containing the accepted quality-of-service profile and a Radio Priority parameter for use on the RLC/MAC layer. Thus, the network defines the quality-of-service profile for the PDP context, and the quality-of-service profile requested by the mobile station MS cannot always be realized. The information element containing the quality-of-service profile is described in the 3GPP specification TS 24.008, v. 6.1.0, June 2003, paragraph 10.5.6.5, and the Radio Priority information element in paragraph 10.5.7.2. The mobile station MS stores this and other PDP context-related information (e.g. the LLC SAPI identifier). After this, the first PDP context can be used in data transmission from the mobile station to the GPRS network and vice versa.

In step 302, typically when there is a need to begin the transmission of packets of another application or the same application that requires a different quality of service, a second PDP context is arranged for the mobile station for the transmission of the data packets of a second logical data flow. In such a case, it is possible to act in the manner already illustrated above or alternatively, to activate a secondary PDP context in the manner described in the 3GPP specification 23.060, paragraph 9.2.2.1.1, after which the mobile station MS has two parallel PDP contexts. After step 302, the mobile station thus has at least two separate PDP contexts that have different quality-of-service profiles. It should also be noted that in step 301 and/or 302, the network could request the activation of the PDP context, which is illustrated in paragraph 9.2.2.2.

According to a preferred embodiment, the mobile station MS is arranged to transmit to the RLC/MAC layer information on the quality-of-service class of the packet to be transmitted, this class thus being the quality-of-service class of the PDP context used in the transmission of the packet. The quality-of-service class defines the application type and especially its delay sensitivity. The RLC/MAC layer is, in turn, arranged to use this information in the definition of the transmission order of the packets being transmitted. According to an embodiment, the method illustrated in the following employing the quality-of-service class is used to define the order of transmission on the RLC/MAC layer.

When the RLC/MAC layer has at least two data packets waiting for transmission in step 304, the mobile station MS is arranged to check the Radio Priority parameters in the packets. If, on the basis of the check 305, 306, they are different, the mobile station MS first transmits in step 307 the packet having the higher Radio Priority parameter.

If the Radio Priority parameters are the same in both packets, the mobile station MS is, according to one embodiment, arranged to check 308, 309 the Traffic Class parameter, i.e. the quality-of-service class defined in the GPRS quality-of-service profile. The Traffic Class parameter defines the application type, for which the transmission service is optimized. The 3GPP specification TS 23.107, version 5.9.0, June 2003, specifies the quality-of-service concept and architecture of the 3GPP system, and especially the parameters defining different quality-of-service classes that can form the quality-of-service profile for the PDP context. At the moment, there are four defined Traffic Classes: conversational, streaming, interactive, and background. These classes are described in greater detail in the above-mentioned 3GPP specification 23.107, and their names, too, already describe their use, the conversational class, for instance, is intended for the most delay-sensitive data.

If the data packets to be transmitted have different Traffic Class parameters, the packet having the higher Traffic Class parameter is transmitted first in step 310. According to one embodiment, the classes are arranged in the following order:
1. conversational class
2. streaming class
3. interactive class
4. background class.

The data packets of a PDP context in the conversational class are then always transmitted before other packets with the same Radio Priority parameter. The packet data buffering function performed by the RLC/MAC layer is arranged to buffer a packet with a lower Radio Priority parameter to a transmission queue while a packet with a higher Radio Priority parameter is being transmitted, and to transmit the packet after this. It should be noted that another type of order could also be applied.

The embodiment illustrated above provides the advantage that the real-time properties of the data to be transmitted can efficiently be taken into account on the RLC/MAC layer when transmitting the data.

If the Traffic Class parameters are the same on the basis of the check 308, 309, it is, according to one embodiment, possible to use a third classification parameter. One such third classification parameter is the Peak Throughput Class that can be checked in step 311. The packet having the highest Peak Throughput Class is then transmitted before the others.

Information on the quality-of-service class can be transmitted to the RLC/MAC layer in many ways. In one embodiment, MS transmits the quality-of-service class parameter from the LLC layer to the RLC/MAC layer in a service request primitive. The LLC layer can add the Traffic Class quality-of-service class parameter to a GRR-DATA-REQ primitive that is used to request reliable transmission of the LLC data unit from the RLC/MAC layer. Service primitives between the LLC layer and the RLC/MAC layer are described in the 3GPP specification TS 44.064, v. 5.1.0, March 2002, paragraphs 7.1.2 and 7.2.3, which defines that the Radio Priority parameter and the Peak Through put Class parameter are transmitted in the GRR-DATA-REQ primitive. The implementation of the present embodiment requires that, instead of or in addition to the Peak Throughput Class parameter, the Traffic Class be defined as a parameter for the GRR-DATA-REQ primitive. The LLC-layer entity modified according to the present embodiment is then arranged to check the Traffic Class parameter from the information of the PDP context used for the data packet to be transmitted and to add it to the GRR-DATA-REQ primitive comprising the data packet. The modified RLC/MAC-layer entity is arranged to define from the received GRR-DATA-REQ primitive the Traffic Class parameter and to use it in the manner illustrated in FIG. 3 for defining the transmission order of the data packets. When the data packet is defined for transmission in step 307, 310 or 312, it can be transmitted from the RLC/MAC layer in accordance with the above-mentioned 3GPP specification TS 44.060. The quality-of-service class parameter can also be used in GRR-UNITDATA-REQ primitives, with which the LLC layer can request unreliable data transmission.

The above illustrates a classification method for packets to be transmitted that utilizes the Radio Priority, Traffic Class, and Peak Throughput Class parameters. It should be noted that, alternatively, it is also possible to use other quality-of-service parameters, for instance instead of the Peak Throughput Class parameter, another parameter defined in the quality-of-service profile. It should also be noted that according to one alternative embodiment, one or more classification parameters, for instance information defining the quality-of-service class, is not added to the packet to be transmitted, but is checked elsewhere, for instance in the information of the PDP context, to which the packet belongs.

It is apparent to a person skilled in the art that while the technology advances, the basic idea of the invention can be implemented in many different ways. The invention can also be applied to a system that supports some other RLC/MAC layer than the above RLC/MAC layer according to the 3GPP specifications, and in which different quality-of-service classes can be defined for data flows. The invention and its embodiments are thus not restricted to the examples described above, but may vary within the scope of the claims. Thus, features can be left out, modified, or replaced with equivalents.

1. A method of data transmission for a mobile station of a wireless packet-switched data system that requires the definition of a transmission order in a radio link layer for a data packet of a first data flow and a data packet of a second data flow, wherein a transmission order for data packets on the basis of at least one classification parameter is defined in the radio link layer, the method comprising:
checking according to the classification parameter the quality-of-service class of the first and second data flows, and
transmitting the data packet of the data flow having the higher quality-of-service class first.

2. A method as claimed in claim 1, wherein the quality-of-service class indicates the delay sensitivity of an application.

3. A method as claimed in claim 2, wherein the parameter defining the quality-of-service class defines the Traffic Class defined in the quality-of-service profile allocated to the data flow, and
in accordance with the Traffic Class, the data packets are transmitted in the following order from the first to the last: conversational, streaming, interactive, background.

4. A method as claimed in claim 1, wherein the method is applied to data packets received from the link layer of the GPRS system in the mobile station.

5. A method as claimed in claim 1, wherein a transmission order is defined for the data packets on the basis of a first classification parameter attached to them, and
in response to the data packets having the same first classification parameter, a transmission order is defined on the basis of a second classification parameter attached to the data packets, the second classification parameter being said parameter defining the quality-of-service class.

6. A method as claimed in claim 1, wherein:
the method is applied to data packets received from the link layer of the GPRS system in the mobile station;
a transmission order is defined for the data packets on the basis of a first classification parameter attached to them; and
in response to the data packets having the same first classification parameter, a transmission order is defined on the basis of a second classification parameter attached to the data packets, the second classification parameter being said parameter defining the quality-of-service class, and the first classification parameter being a parameter defining the radio priority of the RLC/MAC layer.

7. A method as claimed in claim 5, wherein in response to the first and second data flows having the same quality-of-service class, a transmission order is defined on the basis of a third classification parameter of the first and second data flows.

8. A mobile station comprising a transceiver for arranging wireless packet-switched data transmission and organizing means for defining in a radio link layer the transmission order of a data packet of a first data flow and a data packet of a second data flow on the basis of at least one classification parameter, wherein
the organizing means are configured to check the quality-of-service class of the first and second data flows in accordance with the classification parameter, and
the mobile station is configured to transmit the data packet of the data flow having the higher quality-of-service class first.

9. A mobile station as claimed in claim 8, wherein the quality-of-service class indicates the delay-sensitivity of an application.

10. A mobile station as claimed in claim 9, wherein the organizing means are configured to check the parameter Traffic Class defining the quality-of-service class.

11. A mobile station as claimed in claim 8 wherein the organizing means organize data packets received from the link layer of the GPRS system.

12. A mobile station as claimed in claim 9, wherein:
the organizing means organize data packets received from the link layer of the GPRS system;
the organizing means are configured to check the parameter Traffic Class defining the quality-of-service class, wherein an LLC-layer entity of the mobile station is configured to add the Traffic Class parameter to a service primitive comprising a LLC data unit; and
an RLC-layer entity of the mobile station is configured to define the Traffic Class parameter from the service primitive received from the LLC layer for use in defining the transmission order.

13. A mobile station as claimed in claim 8, wherein the organizing means are also configured to define for the data packets a transmission order on the basis of a first classification parameter attached to them, and
the organizing means are also configured to define, in response to the data packets having the same first classification parameter, a transmission order on the basis of a second classification parameter attached to the data packets, the second classification parameter being said parameter defining the quality-of-service class.

14. A mobile station as claimed in claim 13, wherein the first classification parameter is a parameter that defines the radio access priority of the RLC/MAC layer.

15. A mobile station as claimed in claim 13, wherein the organizing means are configured to define, in response to the first and second data flows having the same quality-of-service class, a transmission order on the basis of a third classification parameter of the first and second data flows.

16. A telecommunications system comprising a mobile station and a network, wherein the definition of the transmission order of a data packet of a first data flow and a data packet of a second data flow in a radio link layer is arranged on the basis of at least one classification parameter, whereby
the system is configured to check according to the classification parameter the quality-of-service class of the first and second data flows, and
the system is configured to transmit the data packet of the data flow having the higher quality-of-service class first.

17. A computer program loadable into a memory of a mobile station comprising organizing means for defining the transmission order of a data packet of a first data flow and a data packet of a second data flow in a radio link layer, wherein the computer program comprises computer program code which, when executed in a processor of the mobile station causes the mobile station to:
check the quality-of-service class of the first and second data flows in accordance with the classification parameter, and
transmit the data packet of the data flow having the higher quality-of-service class first.
